(19) United States
(12) Patent Application Publication
(10) Pub. No.: US 2017/0024124 A1
(43) Pub. Date: Jan. 26, 2017

(54) INPUT DEVICE, AND METHOD FOR CONTROLLING INPUT DEVICE

(71) Applicant: SHARP KABUSHIKI KAISHA, Sakai City, Osaka (JP)

(72) Inventors: Masafumi UENO, Sakai City (JP); Tomohiro KIMURA, Sakai City (JP); Yasuhiro SUGITA, Sakai City (JP)

(21) Appl. No.: 15/302,232

(22) PCT Filed: Apr. 8, 2015
(86) PCT No.: PCT/JP2015/060979

§ 371 Date: Oct. 6, 2016

(30) Foreign Application Priority Data
Apr. 14, 2014 (JP) 2014-083082

(51) Int. Cl. G06F 3/0488; G06F 3/041; G06F 1/16

(52) U.S. Cl. CPC G06F 3/04883; G06F 1/1626; G06F 3/0416; G06F 2203/04108; G06F 2200/1636; G06F 2203/04104; G06F 3/044

(57) ABSTRACT

In an end portion of a case of a portable terminal, an operation that uses a movement of an operation object perpendicular to the case is possible. A portable terminal (1) includes a movement direction determination unit (52a) that determines a direction in which an operation object is moved along a direction which includes one edge of a case of an input device and which is approximately perpendicular to one surface of the case including the edge, in the vicinity of an end portion and a side surface of the case of the input device, based on a change in a pattern of a detection signal over time indicating that the operation object is detected.

### TECHNICAL FIELD

The present invention relates to an input device that processes an operation which is input, a method for controlling the input device, and the like.

### BACKGROUND ART

In recent years, with advances in multi-functionality of a portable terminal, such as a smartphone or a tablet, there has been an increasing need to process various input operations. For example, a portable terminal is known in which, in order to enable a touch operation in an end portion (edge) of a case of the portable terminal, a distance between the end portion of the case of the portable terminal and an end portion of a display screen, that is, a width of a portion that is called a frame is reduced (or is rarely present). Furthermore, it is known that it is also possible that a touch sensor is provided on a side surface of the case and a touch operation is performed on the side surface of the case of the portable terminal.

Disclosed in PTL 1 are a device and a method for controlling an interface for a communications device that uses an edge sensor which detects a finger arrangement and an operation.

### CITATION LIST

### Patent Literature

PTL 1: Japanese Unexamined Patent Application Publication (Translation of PCT Application) No. 2013-507684 (published on Mar. 4, 2013)

### SUMMARY OF INVENTION

### Technical Problem

However, a problem with the control of the interface by the edge sensor that is positioned on a side surface of a device in PTL 1 is that an operation that is able to be input is limited to only an operation along the side surface of the device and in a one-dimensional direction parallel to a display screen. Because of this limitation, only an operation, such as a scrolling operation or a zoom operation (zoom-in or zoom-out), that is controllable with input of the operation in the one-dimensional direction can be performed.

An object of the present invention, which was made to deal with the problems described above, is to realize an input device, a method for controlling the input device, and the like, in all of which it is possible that an operation which uses an end portion of a case of the input device is used.

### Solution to Problem

In order to deal with the problems described above, according to an aspect of the present invention, there is provided an input device that acquires an operation by an operation object, the input device including: an operation sensing unit that senses an operation object that is present within a virtual operation surface that includes an edge of a case of the input device and that is approximately perpendicular to one surface of the case including the edge; and a movement direction determination unit that determines whether the operation object that is sensed by the operation sensing unit moves in a direction toward the edge, or moves in a direction away from the edge, in which a direction of movement of the operation object that is determined by the movement direction determination unit is acquired as an operation by the operation object.

Furthermore, in order to deal with the problems described above, according to another aspect of the present invention, there is provided a method for controlling an input device that acquires an operation by an operation object, the method including an operation sensing step of sensing an operation object that is present within a virtual operation surface that includes an edge of a case of the input device and that is approximately perpendicular to one surface of the case including the edge, a movement direction determination step of determines whether the operation object that is sensed in the operation sensing step moves in a direction toward the edge, or moves in a direction away from the edge, and an operation detection step of acquiring a direction of movement of the operation object that is determined in the movement direction determination step, as an operation by the operation object.

### Advantageous Effects of Invention

According to one aspect of the present invention, an effect is achieved in which, in the vicinity of an end portion and a side surface of the case of the input device, in the vicinity of an end portion and a side surface of the input device, an operation that uses a movement of an operation object along a direction that includes one edge of a case of an input device and that is approximately perpendicular to one surface of the case including the edge can be used.

### BRIEF DESCRIPTION OF DRAWINGS

FIG. 1 is a block diagram illustrating an example of an essential-element configuration of a portable terminal according to a first embodiment of the present invention.

FIGS. 2(a) to 2(c) are diagrams illustrating a movement of a finger that performs an input operation which is detectable by the portable terminal according to the present invention.

FIG. 3(a) is a diagram illustrating a movement of a finger that performs the input operation that is detectable by the portable terminal in a case where a frame region between an end portion of a case of the portable terminal in FIG. 2 and an end portion of a screen is narrow, or is not present, and FIGS. 3(b) and 3(c) are diagrams for describing an example that is used to determine a direction of movement of the detected finger.

FIG. 4 is a diagram illustrating the movement of the finger that performs the input operation which is detectable by a portable terminal according to a second embodiment of the present invention.

FIGS. 5(a) and 5(d) are diagrams illustrating an example of positioning a touch panel that is included in a portable terminal 1 according to a third embodiment of the present invention. FIGS. 5(b) and 5(c) are diagrams of the movement of the finger that performs the input operation which is detectable by the portable terminal according to the third embodiment.

FIG. 6 is a diagram illustrating the movement of the finger that performs the input operation that is detectable by the portable terminal in FIG. 5.

FIG. 7 is a block diagram illustrating an example of a schematic configuration of a portable terminal according to a fourth embodiment of the present invention.

FIGS. 8(a) to 8(d) are diagrams for describing a specific example of configuring a region in which the input operation is possible, to a limited extent according to a type of gripping of the portable terminal.

FIGS. 9(a) to 9(h) are diagrams illustrating one example of a relationship between the input operation that is performed on the portable terminal, and processing that is associated with the input operation.

FIGS. 10(a) to 10(e) are diagrams illustrating an example of the portable terminal taking a non-rectangular shape.

### DESCRIPTION OF EMBODIMENTS

As an example, a case where an input device according to the present invention functions as a portable terminal 1 will be described. However, the input device according to the present invention is not limited to functioning as the portable terminal 1, and can function as any of various devices, such as a multifunctional mobile phone, a tablet, a monitor, and a television.

Furthermore, the upper surface of the portable terminal 1, unless otherwise specified, will be described below as a rectangular plate-shaped member, but is not limited to this. The upper surface may have an elliptical shape or a circular shape, or the like. Alternatively, instead of being a plate-shaped member, the upper surface may be an uneven surface. That is, as long as a configuration that makes it possible to realize a function that will be described below is employed, any shape may be taken.

[Operation of Providing Input to the Portable Terminal 1]

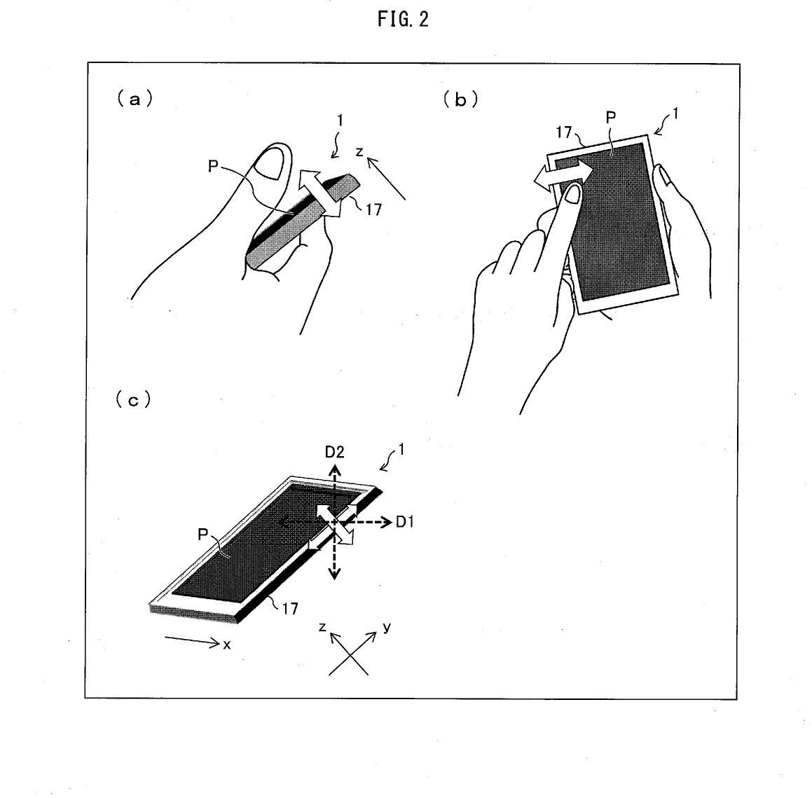

First, one example of an operation of enabling input to the portable terminal is described referring to FIG. 2. FIGS. 2(a) to 2(c) are diagrams illustrating a movement of a finger that performs an input operation which is detectable by the portable terminal 1 according to the present invention.

FIG. 2(a) illustrates a situation in which, in order to perform an operation, a user who uses the portable terminal 1 grips the portable terminal 1 with his/her right hand and moves the thumb (an operation object) of his/her right hand in a direction almost perpendicular to a display screen P, that is, in the direction (the depth direction or the z-axis direction) of an arrow that is illustrated, in a spatial region outside of a spatial region almost right above the display screen P, which is a spatial region in the vicinity of an edge of a case 17 of the portable terminal 1 and a side surface of the portable terminal 1.

FIG. 2(b) illustrates a situation in which, in order to perform an operation, the user who uses the portable terminal 1 grips the portable terminal 1 with his/her hand, brings the forefinger (the operation object) of his/her left hand close to an end portion of the case 17 of the portable terminal 1, and moves the forefinger in the depth direction (the z-axis direction), in the spatial region outside of the spatial region almost right above the display screen P. That is, unlike in FIG. 2 (a), in FIG. 2(b), the operation is performed with a hand other than the hand that grips the portable terminal 1. Then, the operation that is illustrated in FIG. 2(b) is performed in the vicinity of an edge of the case and a side surface of the portable terminal 1, which are opposite to the vicinity of the edge of the case, where the operation that is illustrated in FIG. 2(a) is performed, and the side surface of the portable terminal 1, respectively.

In FIG. 2(c), it is detected that the finger moves in a direction (the y-axis direction) parallel to the display screen P along the side surface of the case 17 in the vicinity of the end portion of the case 17 and the side surface of the portable terminal 1 and that the finger moves in a direction (the z-axis direction) perpendicular to the parallel direction. Accordingly, it is illustrated that, in the vicinity of the edge of the case 17 and the side surface of the portable terminal 1, it is possible to perform an operation that simulates an imaginary cross key and a two-dimensional operation on a yz plane (an imaginary operation plane) including the right edge of the case 17, for example, such as direction D1, or direction D2. At this point, four directions that are indicated by the cross keys are a direction toward the edge of the case 17, a direction of moving away from the edge, a direction of moving along the edge in one direction, and a direction of moving along the edge in the opposite direction.

Moreover, it is also possible that, with detection of a touch operation, it is recognized that the finger moves in the direction (the y-axis direction) parallel to the display screen P along the side surface of the case 17, and that, with detection of a hovering operation, it is recognized that the finger moves in the direction (the z-axis direction) perpendicular to the parallel direction. A method will be described below in which the “hovering operation” and the “touch operation” are enabled to be compatible with each other using only the touch panel 14 in a case where the portable terminal 1 includes a touch panel (an operation sensing unit) 14 that is superimposed on the display screen P.

In a case where the touch panel 14 is of the capacitive type, an electrostatic capacitance between a drive electrode and a sensor electrode is measured and thus the “touch operation” is detected. A scheme of measuring the electrostatic capacitance between the drive electrode and the sensor electrode, which is referred to as a mutual capacitance scheme, is suitable for “the touch operation” because an electric line of force occurs in the vicinity of an electrode between the drive electrode and the sensor electrode. On the other hand, the drive electrode and the sensor electrode are driven as individual electrodes, and by using a self-capacitance scheme of measuring an electrostatic capacitance between the electrode and the finger, the electric line of force is extended between the electrode and the finger. Because of this, detection of the “hovering operation” is possible. That is, the mutual capacitance scheme and the self-capacitance scheme are enabled to be compatible with each other (to be available together) within the same touch panel 14, and thus it is possible that the “hovering operation”, and the “touch operation” are detected. Alternatively, the “hovering operation” and the “touch operation” may be detected by performing switching temporally, such as by alternately performing the driving using the mutual capacitance scheme and the driving self-capacitance scheme.

Moreover, arrows in FIGS. 2 to 6, 8, and 9 indicate a direction of movement of the finger, and do not indicate a breadth (width) of a region on which the finger is able to be sensed.

[Configuration of the Portable Terminal 1]

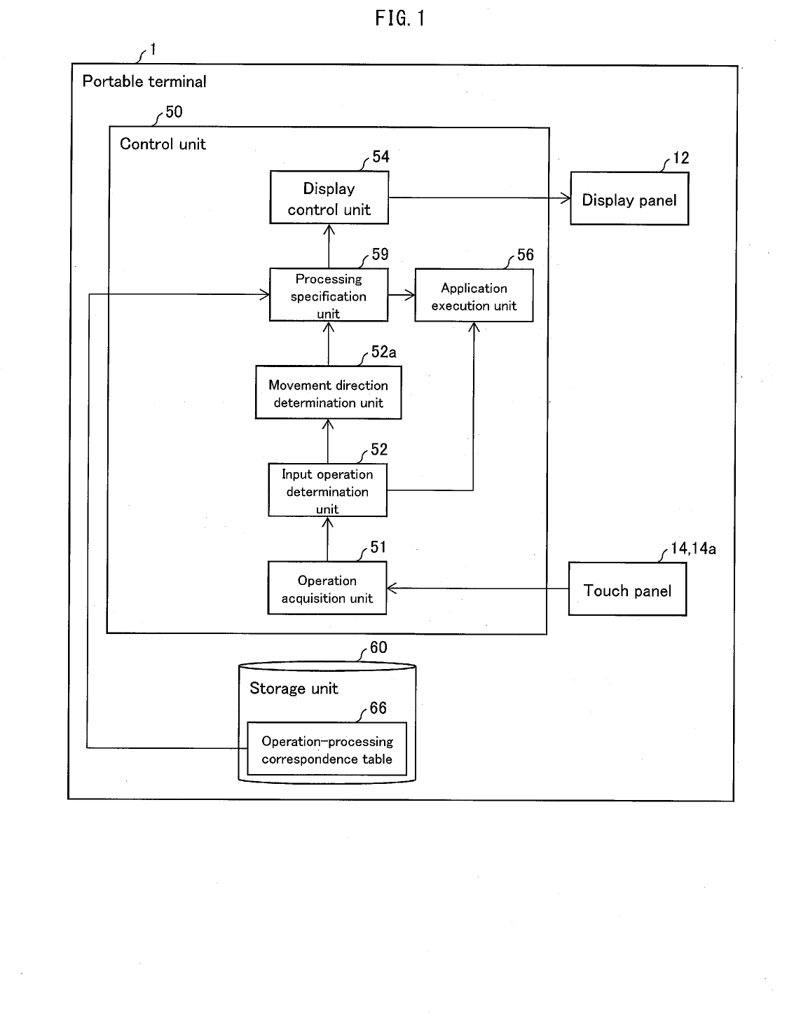

First, a schematic configuration of the portable terminal 1 is described referring to FIG. 1. FIG. 1 is a block diagram illustrating an example of an essential-element configuration of the portable terminal 1 according to a first embodiment of the present invention. At this point, only a configuration (particularly, a configuration relating to input of an operation in the vicinity of the end portion of the case of the portable terminal 1) for the portable terminal 1 to detect the input operation is illustrated. In addition to this, the portable terminal 1 is equipped with a general function of a smartphone, but a description of a portion that has no direct relationship to the present invention is omitted.

A control unit 50 collectively controls each unit of the portable terminal 1, and mainly includes an operation acquisition unit 51, an input operation determination unit 52, a movement direction determination unit 52a, a processing specification unit 59, an application execution unit 56, and a display control unit 54, as functional blocks. The control unit 50, for example, executes a control program, and thus controls each member that constitutes the portable terminal 1. The control unit 50 reads a program, which is stored in a storage unit 60, into a temporary storage unit (not illustrated) that is constituted by a Random Access Memory (RAM) and the like, for execution, and thus performs various processing operations, such as processing by each member described above. Moreover, in the case of the portable terminal 1 in FIG. 1, the input device according to the present invention functions as the touch panel 14 and a touch panel 14a, the operation acquisition unit 51, the input operation determination unit 52, the movement direction determination unit 52a, and the processing specification unit 59.

In order to perform control of various functions of the portable terminal 1, the operation acquisition unit 51 detects a position of the operation object (the user's finger, a stylus, or the like) that is detected on the display screen P of the portable terminal 1, and in the region in the vicinity of the end portion or the side surface of the case 17 of the portable terminal 1, and acquires the input operation that is input by the operation object.

The input operation determination unit 52 determines whether the input operation that is acquired by the operation acquisition unit 51 is based on contact or proximity of the operation object, such as the finger, to the display screen P or is based on the contact or the proximity of the finger or the like to the region in the vicinity of the end portion or the side surface of the case 17 of the portable terminal 1. The input operation determination unit 52 checks which position of the touch panel 14 a position in which a change in capacitance on which a detection signal that is acquired by the operation acquisition unit 51 is based is detected is, and thus makes the determination.

In a case where the operation object is detected in the region in the vicinity of the end portion or the side surface of the case 17 of the portable terminal 1, based on a change in an absolute value of a difference in intensity over time between the detection signal indicating that the operation object is detected and a detection signal indicating that the operation object is not detected, the movement direction determination unit 52a determines a direction of movement of the detected operation object. Furthermore, based on a change in a shape or an area of a region on an operation sensing unit over time, in which the absolute value of the difference in intensity between the detection signal indicating that the operation object is detected and the detection indicating that the operation object is not detected is greater than a prescribed threshold, the movement direction determination unit 52a may determine the direction of the movement of the detected operation object. This processing that determines the direction of the movement of the detected operation object will be described in detail below.

The processing specification unit 59 specifies processing that is allocated to a direction of movement of the operation object, which is determined by the movement direction determination unit 52a, referring to an operation-processing correspondence table 66 that is stored in the storage unit 60. Information (a specific result) relating to the specified processing is output to the application execution unit 56 and the display control unit 54.

The application execution unit 56 acquires a result of the determination from the operation acquisition unit 51 and the specific result from the processing specification unit 59, and performs processing operations by various applications that are installed on the portable terminal 1, which are associated with the result of the determination and the specific result that are acquired from these.

The display control unit 54 controls a data signal line drive circuit, a scan signal line drive circuit, a display control circuit, and the like, and thus displays an image corresponding to the processing that is specified by the processing specification unit 59, on a display panel 12. Moreover, according to an instruction from the application execution unit 56, the display control unit 54 may control the display on the display panel 12.

The display panel 12 can employ a well-known configuration. At this point, the case where the display panel 12 that is a liquid crystal display is included is described, but the display panel 12 is not limited to this and may be formed as a plasma display, an organic EL display, a field emission display, or the like.

The touch panel 14 is superimposed on the display panel 12, and is a member that senses the contact or the proximity of the user's finger (the operation object), an instruction pen (the operation object), or the like, at least to the display screen P of the display panel 12. That is, it is possible that the touch panel 14 functions as a proximity sensor that detects the proximity of the operation object to the display screen P. Accordingly, it is possible that the user's input operation which is performed on the image that is displayed on the display screen P is acquired, and operational control of a prescribed function (various applications) that is based on the user's input operation is performed.

### First Embodiment

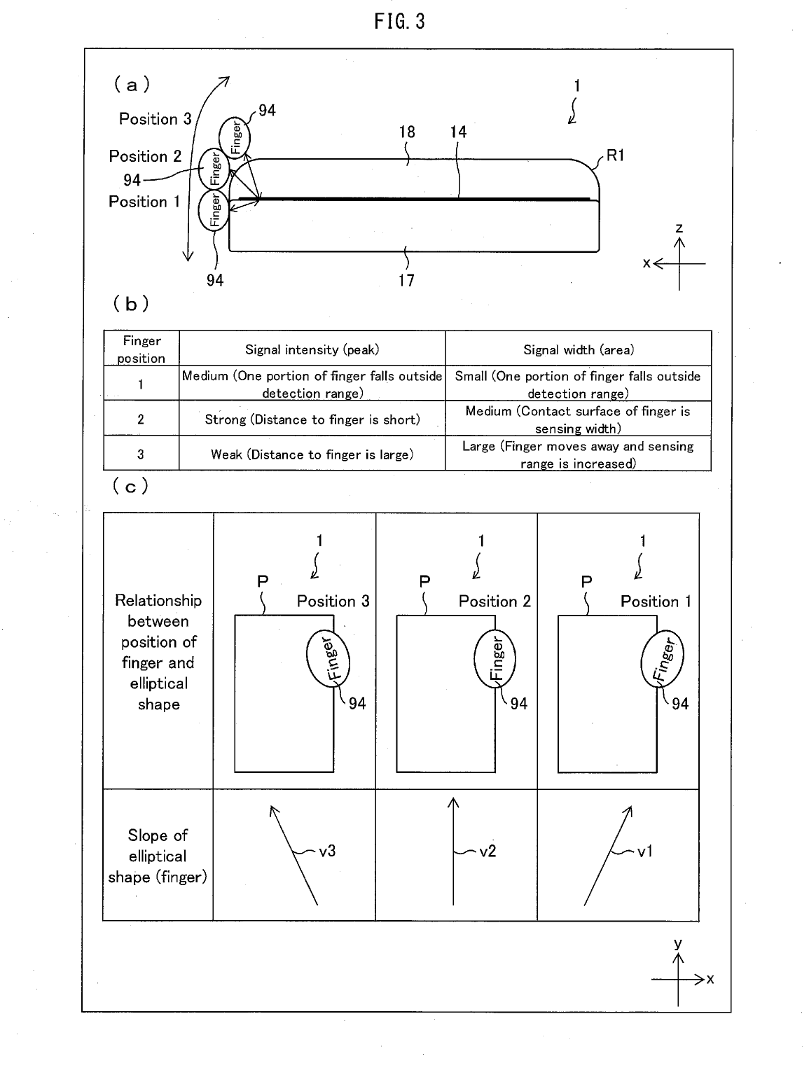

Referring to FIG. 3, one aspect of the embodiment of the present invention will be described as follows.

First, a method in which the movement direction determination unit 52a determines a direction of movement of a finger 94, using the portable terminal 1 is described referring to FIG. 3. FIG. 3(a) is a diagram illustrating a movement of the finger 94 that performs the input operation that is detectable by the portable terminal 1 in a case where a frame region between an end portion of the case 17 of the portable terminal 1 in FIG. 2 and an end portion of the display screen P is narrow, or is not present, and FIGS. 3(b) and 3(c) are diagrams for describing an example that is used to determine the direction of the movement of the detected finger 94. Moreover, in FIG. 3(a), an example of the touch panel 14 (not illustrated) that is superimposed on the display panel that is housed in the case 17 and of the portable terminal 1 in which a protective glass 18 is stacked on the touch panel 14 is illustrated, but is not limited to this. Moreover, the touch panel 14 may be any touch panel that can detect the touch operation with the contact of the finger 94 to the protective glass 18, and may not be a touch that can detect the hovering operation.

The protective glass 18 is a plate-shaped member that has transparency, and is positioned in such a manner as to cover the touch panel 14 in order to protect the touch panel 14 from an external shock. Furthermore, the protective glass 18 has a cut-out portion R1 (a cut-out shape) in an end portion (an outer edge) thereof, and changes a direction of light that is emitted from the display panel 12. The inclusion of the protective glass 18 that has the cut-out portion R1 can increase the accuracy of the sensing by the touch panel 14 at an outer edge of the portable terminal 1. Furthermore, a direction in which light that is emitted from pixels which are arranged at the outer edge of the display panel 12 propagates is changed by the cut-out portion R1, and the light is emitted from a region (non-display region) outside of the pixels. Therefore, a viewing angle (a display region when viewed from the user) of the image can be increased. Moreover, in a case where the protective glass 18 may not have a function of increasing the viewing angle, the protective glass 18 does not necessarily need to have the cut-out portion R1.

Moreover, a well-known touch panel may be used as the touch panel 14. Because it is possible that the well-known touch panel is driven at approximately 240 Hz, it is possible that an operation which uses the movement of the finger 94 as illustrated in FIG. 3(a) is tracked and the direction of the movement of the finger 94 is determined.

[Processing that Determines the Direction in which the Operation Object Moves]

A method will be described in which the movement direction determination unit 52a determines a direction of movement of the operation object.

FIG. 3(a) illustrates one example of an operation that results from the movement of the finger 94 in the direction (the z-axis direction) perpendicular to a surface (an xy plane) of the touch panel 14 in the vicinity of the end portion of the case 17 of the portable terminal 1. As illustrated in FIG. 3(a), in a case where an operation is performed along an outer edge in the vicinity of the side surface of the portable terminal 1, the distance between the finger 94 and the touch panel 14, and a finger touch area (contact area), which is formed by side surfaces of the cut-out portion R1 of the protective glass 18 and the case 17, and the finger 94, change. For this reason, the intensity of the detection signal, which indicates that the finger 94 has been detected, and the shape of the region in which the finger 94 was detected change. Based on this change, it can be determined whether the direction of the movement of the finger 94 is a direction from position 1 to position 3, or is a direction from position 3 to position 1. Moreover, the finger 94 in position 3 is a distance away from a surface of the protective glass 18.

As illustrated in FIG. 3(b), the intensity (a signal intensity (peak)) of the detection signal indicating that the finger 94 is detected differs according to the distance between the finger 94 and the touch panel 14. That is, in a case where the finger 94 approaches the touch panel 14 from a distant place, and in a case where the finger 94 moves farther and farther away from the vicinity of the touch panel 14, a pattern of a change in the intensity of the detection signal over time differs. As an example, a case where the finger 94 moves from position 1 to position 3 will be described below. For the signal intensity by which the finger 94 that is present at position 1 is detected, although the distance between the finger 94 and the touch panel 14 is small, because one portion of the finger 94 falls outside of the detection range of the touch panel 14, the signal intensity is “medium”. When the finger 94 next moves to position 2, because the finger 94 falls within a detection range of the touch panel 14, and the distance between the finger 94 and the touch panel 14 is also short, the signal intensity is “strong”. Thereafter, when the finger 94 moves to position 3, because the distance between the finger 94 and the touch panel 14 is great, the signal intensity is “weak”. Therefore, in a case where the finger 94 moves from position 1 to position 3, the signal intensity of the detection signal changes from “medium” to “strong”. Based on the change in the pattern of the signal intensity over time, the direction of the movement of the finger 94 can be determined.

Alternatively, as illustrated in FIG. 3(b), on the touch panel 14 on which the finger 94 is detected, an area (a signal width (area)) of a region on the touch panel 14, in which the absolute value of the difference in signal intensity between the detection signal indicating that the finger 94 is detected and the detection signal indicating that the finger 94 is not detected is greater than the prescribed threshold, changes by a relative positional relationship between the finger 94 and the touch panel 14. That is, in the case where the finger 94 approaches the touch panel 14 from a distant place, and in the case where the finger 94 moves farther and farther away from the vicinity of the touch panel 14, a pattern of a change in the signal width over time (the detection signal that corresponds to a size of the finger touch area or a sensing area) differs. As an example, the case where the finger 94 moves from position 1 to position 3 will be described below. For the signal width by which the finger 94 that is present at position 1 is detected, the distance between the finger 94 and the touch panel 14 is small and one portion of the finger 94 falls outside the detection range of the touch panel 14. Because of this, the signal width is “weak”. Next, when the finger 94 moves to position 2, because a grounding surface that is a surface with which the finger 94 comes into contact, which is one portion of the protective glass 18, is the sensing width, the signal width increases from “weak” to “medium”. Thereafter, when the finger 94 moves to position 3, because the finger 94 moves farther away from the touch panel 14, the signal width is “strong”. Therefore, in the case where the finger 94 moves from position 1 to position 3, the signal intensity of the detection signal changes from “weak” to “strong”. Based on a change in the pattern of the signal width over time, the direction of the movement of the finger 94 may be determined.

Additionally, as illustrated in FIG. 3(c), on the touch panel 14 on which the finger 94 is detected, the slope or the like of the shape (an elliptical shape) of a region on the touch panel 14, in which the absolute value of the difference in signal intensity between the detection signal indicating that the finger 94 is detected and the detection signal indicating that the finger 94 is not detected is greater than the prescribed threshold, changes by a relative positional relationship between the finger 94 and the touch panel 14. That is, in the case where the finger 94 approaches the touch panel 14 from a distant place, and in the case where the finger 94 moves farther and farther away from the vicinity of the touch panel 14, a pattern of a change in the slope of the elliptical shape over time (the finger) differs. For example, in a case where the finger 94 moves from position 1 to position 3, the slope of the elliptical shape of the finger changes from “v1” through “v2” to “v3”. Based on a change in the pattern of the slope of the elliptical shape over time, the direction of the movement of the finger 94 may be determined.

### Second Embodiment

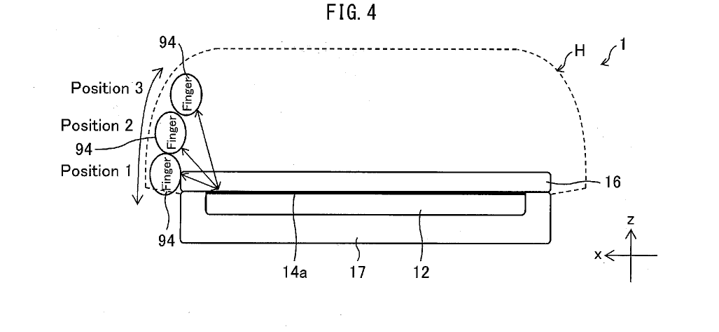

Referring to FIG. 4, another embodiment of the present invention will be described below as follows. Moreover, for convenience of description, a member that has the same function as the member that is described according to the above-described embodiment is given the same reference character, and a description thereof is omitted. FIG. 4 is a diagram illustrating the movement of the finger 94 that performs the input operation which is detectable by the portable terminal 1 according to the second embodiment.

The portable terminal 1 according to the present embodiment is different from the portable terminal 1 that is illustrated in FIG. 3(a), in that the touch panel (the operation sensing unit or the proximity sensor) 14a in which the detection of the hovering operation is possible is superimposed on the display panel 12 and that a cover glass 16 is included instead of the protective glass 18. However, except for this, the members, such as the display panel 12 and the case 17, are the same as the members of the portable terminals 1 in FIGS. 2 and 3.

The cover glass 16 is a plate-shaped member that has transparency, and is positioned in such a manner as to cover the touch panel 14a in order to protect the touch panel 14a from an external cause. Moreover, at this point, it is assumed that a shape of the cover glass 16 is rectangular, but is not limited to this. The cover glass 16 may have a cut-out shape in an end portion (edge) thereof. In this case, because a distance from an outer edge of the cover glass 16 to an end portion of the touch panel 14a can be made small, the accuracy of the sensing by the touch panel 14 can be increased in the outer edge of the portable terminal 1.

The touch panel 14a can detect the hovering operation that is performed on the portable terminal 1. In FIG. 4, a space in which it is possible that the touch panel 14a detects the finger that performs the hovering operation is illustrated as hovering-detectable region H. For example, a well-known touch panel in which it is possible that the hovering operation which is performed on the display screen P is detected can be applied as the touch panel 14a. Furthermore, because it is possible that the well-known touch panel is normally driven at approximately 60 Hz to 240 Hz, it is possible that the operation which uses the movement of the finger 94 as illustrated in FIG. 4 is tracked and the direction of the movement of the finger 94 is determined.

Because hovering-detectable region H in which the end portion of the touch panel 14a can detect the hovering operation, as illustrated in FIG. 4, is broadened by the width of the portable terminal 1, a space region that is farther outwards than the end portion of the touch panel 14a is also included in hovering-detectable region H. Therefore, even in a case where the finger 94 moves between position 1 and position 3, the movement of the finger can be detected (tracked).

In the case of the hovering detection, in the same manner as in the touch operation, the closer the finger 94 is brought to the touch panel 14a, the stronger the signal intensity, and the farther the finger 94 is away, the weaker the signal intensity. Therefore, in the middle of hovering-detectable region H, as is the case with the finger 94 in FIG. 4, in a case where the movement from position 1 to position 3 takes place, the intensity (the signal intensity) of the detection signal, which indicates that the finger 94 is detected, changes from weak to strong. Based on a change in the signal intensity over time, it is possible that the direction of the movement of the finger 94 is determined.

Furthermore, in the hovering detection, the closer the finger 94 is brought to the touch panel 14a, the smaller the signal width (area), and the farther the finger 94 is away, the greater the signal width (area). Therefore, in the middle of hovering-detectable region H, as is the case with the finger 94 in FIG. 4, in the case where the movement from position 1 to position 3 takes place, the signal width (area) indicating that the finger 94 is detected changes from weak to strong. Based on the change in the signal intensity (area) over time, the direction of the movement of the finger 94 may be determined.

### Third Embodiment

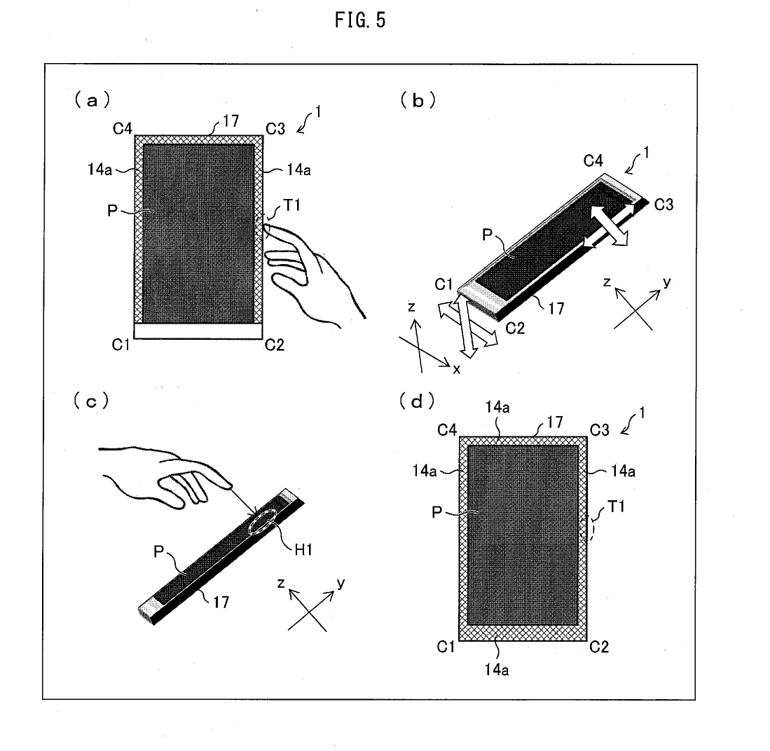

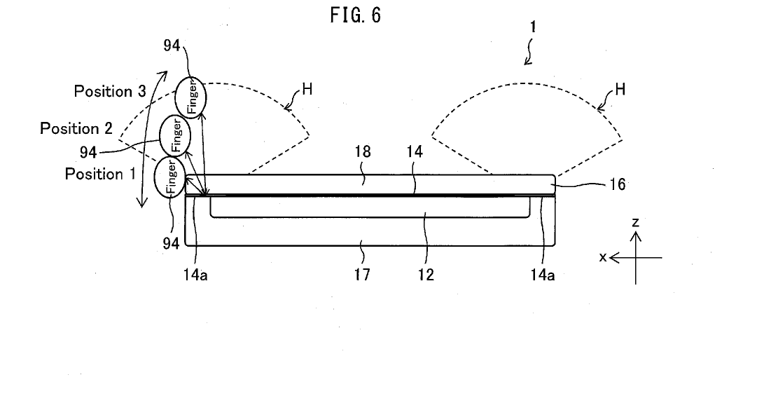

Referring to FIGS. 5 and 6, another embodiment of the present invention will be described below as follows. Moreover, for convenience of description, a member that has the same function as the member that is described according to the above-described embodiment is given the same reference character, and a description thereof is omitted.

The portable terminal 1 according to the present embodiment is different from the portable terminal 1 that is illustrated in FIG. 4, in that the touch panel (the operation sensing unit or the proximity sensor) 14 in which the detection of the touch operation is possible is superimpose on a region that results from excluding an outer-edge portion of the display panel, and in that the touch panel (the operation sensing unit or the proximity sensor) 14a in which the detection of the hovering operation is possible is superimposed only on a surface (a frame region) from an outer-edge portion of the display panel 12 to an end portion of the portable terminal 1. However, except for this, functions of the members, such as the display panel 12, the cover glass 16, and the case 17 are the same as those of the members of the portable terminals 1 in FIG. 4 and other figures.

FIGS. 5(a) and 5(d) are diagrams illustrating an example of positioning the touch panel that is included in the portable terminal 1 according to the third embodiment of the present invention. FIGS. 5(b) and 5(c) are diagrams the movement of the finger that performs the input operation which is detectable by the portable terminal 1 according to the third embodiment.

FIG. 5(a) illustrates a case where the touch panel 14a is provided along three sides, side C2C3, side C3C4, and side C4C1, which are equivalent to the outer edge of the display panel 12. FIG. 5(d) illustrates a case where the touch panel 14a is provided along a side that is equivalent to an entire outer edge of the display panel 12. In this manner, the number of sides along which the touch panel 14a is provided is not limited. Furthermore, the touch panel 14a may be provided along one portion of a side, and may be provided along all sides.

In this manner, in the case of the portable terminal 1 in which a frame-shaped surface is present between the outer edge of the display panel 12 of the portable terminal 1 that includes the display panel 12, and the end portion of the case 17 that houses the display panel 12, the touch panel 14a may be provided on at least one portion of a surface between the outer edge of the display panel 12 and the end portion of the case 17. Because the touch panel 14a can detect the touch operation and the hovering operation that are performed on the touch panel 14a, the movement and the like of the finger 94 in the direction approximately perpendicular to a surface to be included. Accordingly, the movement of the finger 94 within hovering-detectable region H can be detected using the touch panel 14a that is providing in a position close to the finger 94 that is a detection target. Consequently, an operation that is performed on the vicinity of the end portion of the case 17 of the portable terminal 1 can be detected with precision.

Referring to FIG. 6, the above-mentioned configuration is described in detail as follows. FIG. 6 is a diagram illustrating the movement of the finger 94 that performs the input operation that is detectable by the portable terminal 1 in FIG. 5. Because the touch panel 14a is provided between the outer edge of the display panel 12 and the end portion of the case 17 of the portable terminal 1, hovering-detectable region H of the portable terminal 1 in FIG. 6 is limited to a space region in the vicinity of the frame-shaped surface between the outer edge of the display panel 12 and the end portion of the case 17 that houses the display panel 12. However, in hovering-detectable region H of the portable terminal 1 in FIG. 6, the operation that is performed on the vicinity of the end portion of the case 17 of the portable terminal 1 can be detected with more efficiency and precision.

### Fourth Embodiment

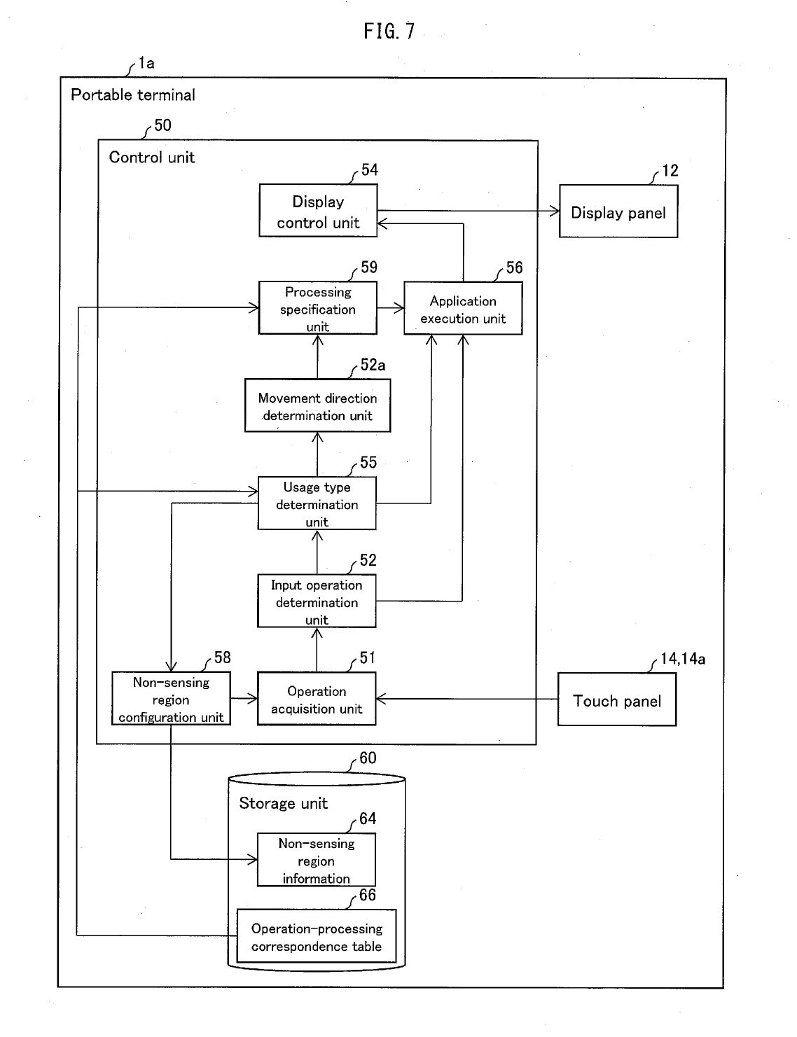

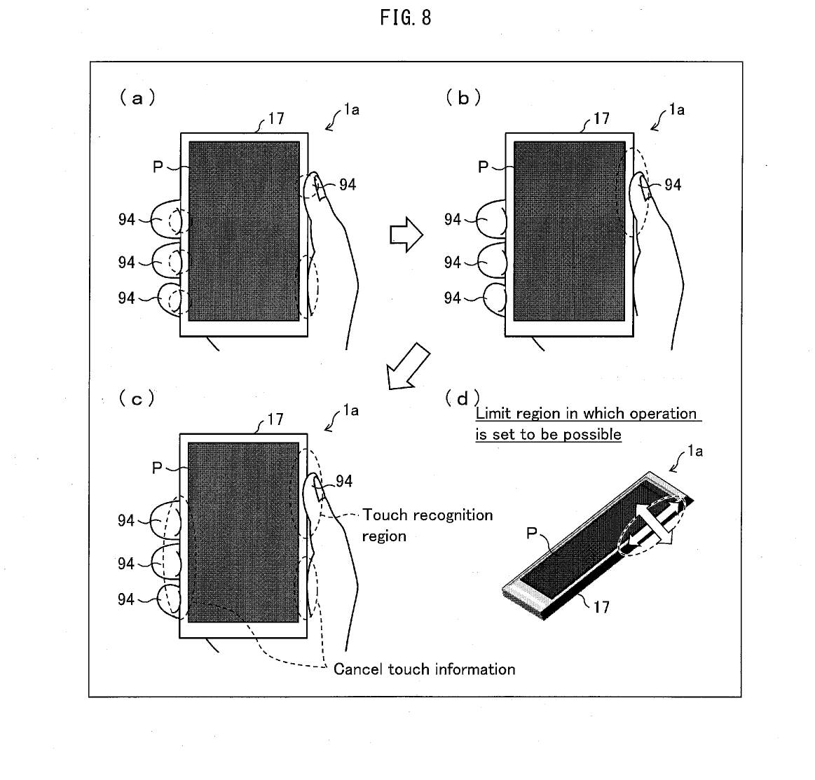

Referring to FIGS. 7 and 8, another embodiment of the present invention will be described below as follows. Moreover, for convenience of description, a member that has the same function as the member that is described according to the above-described embodiment is given the same reference character, and a description thereof is omitted.

[Functional Configuration of the Portable Terminal 1a]

An essential configuration of the portable terminal 1a that is equipped with a function of determining a holding hand will be described below referring to FIG. 7, and suitably FIG. 8. FIG. 7 is a block diagram illustrating an example of a configuration of the portable terminal 1a according to a fourth embodiment of the present invention. FIGS. 8(a) to 8(d) are diagrams for describing a specific example of configuring a region in which the input operation is possible, to a limited extent according to a type of gripping of the portable terminal 1a.

A usage type determination unit (grip determination unit) 55 determines a type of user's usage of the portable terminal 1a according to a touch position of the user's hand, the finger 94, or the like in the end portion of the portable terminal 1a. Specifically, the usage type determination unit 55 determines a type of gripping by the user who grips the portable terminal 1a, according to a position (the touch position) of the contact with the end portion, which is detected. The type of gripping, for example, indicates with which hand the user grips the portable terminal 1a, and the determination of the type of gripping specifically determines whether the user grips the portable terminal 1a with his/her right hand, or with his/her left hand. By determining the type of gripping, approximately a position of each finger of the hand that grips the portable terminal 1a can be specified. Because of this, for example, a finger (for example, a thumb) that is used for the operation can configure a position of a movable region.

The type of gripping, for example, is determined as illustrated in FIG. 8(a). FIG. 8(a) illustrates a situation in which the portable terminal 1a is gripped with a right hand. The number of fingers 94 that comes into contact with the end portion (an end surface) of the portable terminal 1a, and a position of each finger 94 differ depending on with which of the left and right hands the portable terminal 1a is gripped. The tip and the base of the thumb of the hand that grips the portable terminal 1a, and other fingers come into contact with surfaces that are opposite to each other (refer to a region that is surrounded by a broken line in FIG. 8(a)). Therefore, the type of gripping is determined and thus it is possible that a position of the finger 94 (thumb) which is used for the operation is determined.

Additionally, according to the present embodiment, the usage type determination unit 55 determines whether the region is a region in which the finger that is used as the operation object is movable or is a region other than this region, and configures the region in which the finger that is used as the operation object is movable, as an attention region. The attention region indicates a partial region (a region and the vicinity thereof in which the operation is intended to be performed with the thumb and the like) to which the user pays attention while using the portable terminal 1a, among regions in the vicinity of the edge of the case 17 of the portable terminal 1a and the side surface of the portable terminal 1a. For example, as illustrated in FIG. 8(b), the portable terminal 1a that is gripped with the right hand determines a region in which an operation that is input using as the operation object the finger 94 (thumb) of the hand (the right hand) with which the portable terminal 1a is gripped, as a detection-possible region (a region that is surrounded by a broken line in FIG. 8(b)). As illustrated in FIG. 8(d), the operation as illustrated in each of the embodiments described above is possible in the region that is surrounded by the broken line in FIG. 8(b).

A non-sensing region configuration unit 58 configures a region that is brought into contact only for the user to grip the portable terminal 1a, as a non-sensing region. More specifically, in FIG. 8(c), the base portion of the thumb, fingers (a middle finger to a little finger) other than the finger 94 come into contact with the region and the like in the vicinity of the edge of the case 17 and the side surface of the portable terminal 1a, in order to grip the portable terminal 1a. The contact that is sensed these regions is not for the operation that is performed on the portable terminal 1a, and is for simply gripping the portable terminal 1a. It is desirable that contact by fingers and the like that are not used as these operation objects is made not to be acquired as the operation that is performed on the portable terminal 1a, thereby precluding a malfunction and the like. The non-sensing region configuration unit 58 configures the region that is brought into contact only to grip with the portable terminal 1a with the user's hand and the finger 94, as the non-sensing region. Then, in the non-sensing region, touch information indicating the contact by the finger 94 other than the finger 94 (for example, the thumb) that is used as the operation object is canceled. With this configuration, the usage type determination unit 55 makes a holding hand determination, and based on a result of the determination, the non-sensing region configuration unit 58 can limit the region (the attention region) in which the operation that is performed with the thumb on the frame region according to the embodiment describe above is possible, to a range of thumb's reach. That is, the touch panels 14 and 14a sense only the above-described operation object within the yz plane (refer to FIG. 2(C)) that includes the right edge of the case 17, which is included in the region in which a finger that is used as the operation object, such as a thumb, is movable, among fingers of the hand with which the portable terminal 1a is gripped.

Moreover, a holding hand determination method is not limited to what is described at this point. For example, the termination may be made based on information relating to the touch position, which is acquired on an application, and information relating to touch detection on the touch panel controller side may be interpreted for the determination. Furthermore, based on this holding hand information, it is possible that a region (the attention region) the thumb that has a high likelihood of functioning as the operation object performs the operation is also estimated.

Based on these pieces of information, a region (the attention region) in which a cross operation by the thumb in the frame according to the first to third embodiments is limited to the range of the thumb's reach, and touch information that results from other fingers is cancelled (the other regions are set to be the non-sensing regions). Thus, it is possible that the malfunction is precluded and the precise operation is possible.

In a case where the detection of the touch information is set to be possible within a thumb-movable range and the information that results from the other fingers is cancelled, the touch information that is acquired with the application may be determined as being usage/non-usage information, allocation of the touch information may or may not be set to be performed, on a touch panel controller, and the touch information that results from only a recognition region may be set to be output.

The configurations of the first to third embodiments of the present invention are used together with a function of determining the holding hand according to the present embodiment, and thus, the accuracy of the holding hand determination can further be improved. For example, if information relating to the hovering detection according to the second and third embodiments, it can be determined whether the finger is a finger that, like the hand holding the portable terminal 1a, extends from the rear surface of the portable terminal 1a, or is a finger that, like the finger 49 that is used as the operation object, is approached from the display screen P side of the portable terminal 1a. Accordingly, the determination of the handing holding the portable terminal 1 can be made with more accuracy. In addition to this, it is possible that a region that is touched on with a finger or the like with which the portable terminal 1a is gripped for fixation and a region that is touched on for the operation are distinguished from each other. Accordingly, it is possible that the malfunction is precluded with more precision.

[Operability in a Case where the Input Operation that is Detected by the Portable Terminal 1 is Used for Various Applications]

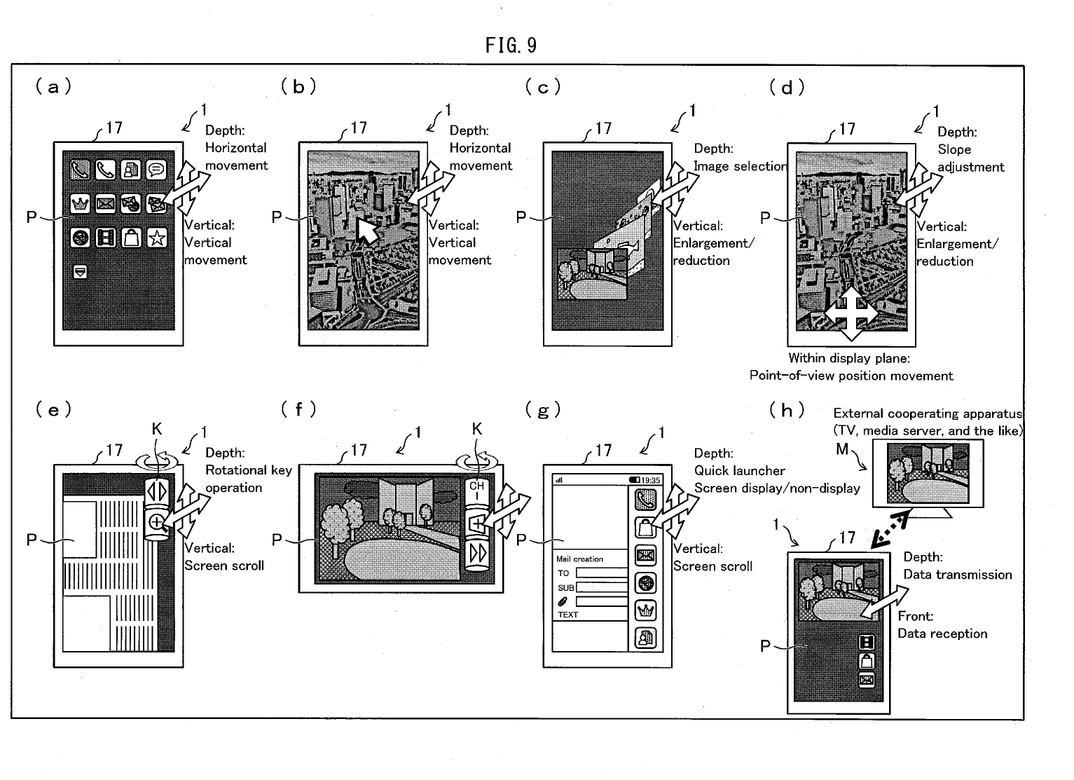

An example of various processing operations that are possible to perform with the input operation which is detected by the portable terminals 1 and 1a will be described below referring to FIG. 9. Particularly, a specific example is described in which, among hovering-detectable regions H, in the spatial region above the vicinity of the end portion of the case 17 of the portable terminal 1, a correspondence relationship is established between an input operation that results from the operation object, such as the user's finger, moving along the direction (the z-axis direction) perpendicular to the display screen P and processing that is performed by the input operation. FIGS. 9(a) to 9(h) are diagrams illustrating one example of a relationship between an input operation that is performed on each of the portable terminal described above, and processing that is associated with the input operation. Moreover, in FIG. 9, the direction (the z-axis direction) perpendicular to the display screen P is indicated as “depth”, and the direction (the y-axis direction) approximately parallel to the display screen P is indicated as “vertical”. Furthermore, an operation that is illustrated in FIG. 9 is not limited to an input position, and it is possible that in any position in which the operation can be detected, the input operation is performed.

The following (1) to (4) are considered as a main operation in the depth direction (the z-axis direction), which is performed on the portable terminal 1, in the vicinity of an edge portion of the portable terminal 1 (for example, in the vicinity of side C1C2, side C2C3, side C3C4, and side C4C1 in FIG. 5).

(1) Operation of changing a selection target, such as an icon, that is displayed within the display screen P/a cursor (pointing device) operation (an icon selection using the cross key/a cursor movement, and the like)

(2) Operation of enabling the display screen p to transition (switching a screen that is displayed, to another screen/channel switching/page turning and returning/and the like)

(3) Operation of moving a target object that is displayed within the display screen P/an operation of performing transformation (changing a slope of the target object/rotating the target object/sliding the target object/enlarging reducing the target object)

(4) Operation of additionally displaying a new function (screen) to the display screen P (shortcut/launcher/dictionary/volume)

As a more specific example, each operation of (1) to (4) described above will be described below.

(1) Operation of Changing the Selection Target, Such as the Icon, that is Displayed within the Display Screen P/the Cursor (Pointing Device) Operation

(a) Cursor Operation Cross Key

An operation in the vertical direction and the depth direction in the vicinity of the edge of the portable terminal 1 is allocated to a movement of the selection cursor as the cross key. As an example of an operation method, as illustrated in FIG. 9(a), a cursor is moved in a direction within the display screen P, which corresponds to a direction in which the user's finger is moved from a position in which the user's finger is first detected, and makes a change of the selection target, such as the icon, that is displayed within the display screen P.

(b) Pointing Device

Because a two-dimensional instruction (pointing) operation is possible, a usage as the pointing device that moves a pointer like a mouse cursor can be available. As an example of the operation method, as illustrated in FIG. 9(a), the pointer within the display screen P is moved from a position of a pointer (an arrow in FIG. 9(b)) that is displayed within the display screen P, in such a manner as to follow the movement of the user's finger from the position in which the user's finger is first detected.

(2) Operation of Enabling the Display Screen P to Transition, and (3) Operation of Moving the Target Object that is Displayed within the Display Screen P/Operation of Performing the Transformation

(c) File Viewer, Such as a Photograph, and the Icon Selection

For example, as illustrated in FIG. 9(c), the closer multiple images, such as a photograph, that is displayed on the display screen P, are brought to the end portion of the display screen P, the more the multiple images are inclined in the depth direction, and it is possible that the multiple images are displayed visually as if the multiple images that are available for display are arranged in the depth direction from the front part of the display screen P. Then, an operation of sending in the depth direction an image that is displayed on the frontmost part of the display screen P is sent in the depth direction of the display screen P, or an operation of returning to the front part of the display screen P an image that is displayed in the depth direction of the display screen P is possible. An operation, such as image enlargement reduction, can be allocated to the vertical direction in the vicinity of the edge of the portable terminal 1.

(d) Operation for Three-Dimensional (3D) Image, Such as a Map Image Viewer

The depth (slope) of the image, such as a map, that is 3D-displayed, is intuitively operated. For example, as illustrated in FIG. 9(d), with the operation in the depth direction, of the upper side of the display screen P, a slope of the map that is 3D-displayed can be adjusted. Specifically, for example, in the case of a bird's-eye view, while a position (an altitude) of a point of view that is a reference for the bird's-eye view is kept fixed, an angle for the bird's-eye view can be changed. The operation, such as image enlargement reduction, can be allocated to the vertical direction in the vicinity of the edge of the portable terminal 1. Moreover, as illustrated in FIG. 9(d), with an operation that results from the movement of the finger in the hovering-detectable region H approximately above the display screen P (that is, within a display plane), or with a touch operation that is performed on the display screen P, an operation of changing the position of the point of view is also possible. In this manner, the input operation is possible using a total of four axes, namely, outside two axes of hovering-detectable region H approximately above the display screen P and inside two axes of hovering-detectable region H approximately above the display screen P.

(e) and (f) Rotational Operation Key Operation

A region in which the input operation is performed is approached, a rotational operation key is displayed on the end portion of the display screen P, and an intuitive operation is performed using the rotational operation key. At this point, the rotational operation key, for example, as illustrated in FIGS. 9(e) and 9(f), is an operation key that imitates a cylindrical shape that a rotational axis parallel to the vertical direction takes, and processing is allocated to an operation, such as rotating this cylinder in the horizontal direction. This rotational operation key is rotated with the input operation in the depth direction, and thus various operations are possible, such as paging turning, an enlargement reduction operation, a file selection of a media player (for example, a channel selection, a song selection, or the like), volume adjustment, and fast forwarding rewinding.

Additionally, another example of a function that is realized by the operation of rotating the rotational operation key with the input operation in the depth direction, rotation and enlargement reduction of an 3D image/3D object, a dial key operation (lock release or the like), character input, a camera zoom operation, and the like are pointed out.

(4) Operation of Additionally Displaying a New Function (Screen) to the Display Screen P

(g) Activation of a Quick Launcher Screen

By performing an operation in the front direction along the operation in the depth direction, a quick launcher (shortcut key) screen is superimposed on the display screen P by operating. As the reverse of this, the display of the quick launcher on the display screen P in a superimposed manner is canceled by performing an operation in the rear direction along the operation in the depth direction. Accordingly, for example, as illustrated in FIG. 9(g), an intuitive operation is possible, such as an operation of drawing another screen, such as the quick launcher screen, from the rear of an image that is displayed on the current display screen P, outwards to the front, or an operation of drawing the quick launcher screen that is currently displayed, inwards to the rear (in the backward direction). Moreover, at this point, as an example, the display/non-display of the quick launcher screen is described, but an operation for controlling the display of a basic configuration screen, a menu display screen, or a key display screen for operating a sound volume or the like of a moving image or the like may be possible.

(h) Cooperation with an Extremal Cooperating Apparatus M

By performing an operation in the rear direction along the operation in the depth direction, data communication with an external cooperating apparatus M, such as transmission of a mail, contribution of an SNS message, sharing of image data such as a photograph, and as the reverse of this, by performing an operation in the front operation along the depth direction, reception (acquisition) of data from the external apparatus is performed such as reception of data. For example, as illustrated in FIG. 9(h), in a case where the portable terminal 1 and the external cooperating apparatus M maintain a communication state in which transmission and reception of data is possible, the transmission and reception of data can be performed between the external cooperating apparatus M and the portable terminal 1 by performing an intuitive operation that uses the movement in the depth direction.

Moreover, as an example, the operation that uses the portable terminal 1 is described above, but an operation that uses the portable terminal 1a may be possible in the same manner.

### Fifth Embodiment

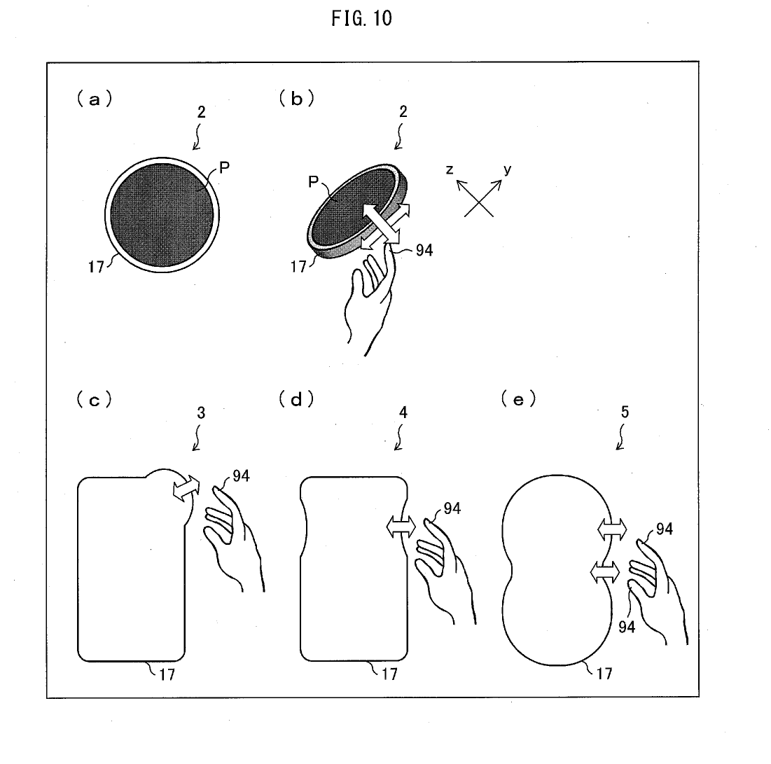

According to the embodiments describe above, the touch operation in the portable terminals 1 and 1a, each taking a rectangular shape, is described, but the shape of the portable terminal is not limited to this. For example, the touch operation may be performed on portable terminals taking various shape, as illustrated in FIG. 10. FIG. 10 is a diagram illustrating an example of the portable terminal taking a non-rectangular shape.

A watch main body and the like of a wrist watch and a pocket watch, as portable terminal 2 taking a circular-plate shape, which is illustrated as an example in FIG. 10(a), for example, result from schematic illustration. A display panel 12 (not illustrated) having a circular or rectangular shape is housed in the case 17 of the portable terminal 2. A touch panel (an operation sensing unit and a proximity sensor) 14 or 14a (not illustrated) may be superimposed on the display panel 12, and the touch panel 14a (not illustrated) in which the detection of the hovering operation is possible may be superimposed only on a surface (a frame region) from an outer edge portion of the display screen P to the end portion of the portable terminal 2. Furthermore, the portable terminal 2 may have the frame region small in width or may not have the frame region as in the embodiments described above.

As illustrated in FIG. 10(b), because a method for determining the direction of the movement of the finger 94 that is used as the operation object, a method in which the region in which the input operation is possible is configured in a limited manner according to the type of gripping, and the like are the same as in the embodiments describe above, descriptions of these are omitted.

As examples of the portable terminals taking other shapes, portable terminals 3, 4, and 5 that are illustrated in FIGS. 10(c) to 10(e), respectively, are pointed out. Any one of the portable terminals includes the touch panel 14 or 14a that senses the finger 94 within a virtual operation surface that includes a circumferential end portion (edge) of the case 17 and that is approximately perpendicular to one surface of the case 17 that includes the circumferential end portion, and as illustrated, acquires an operation that results from the finger 94.

[Example of Realization by Software]

Control blocks (particularly, an operation acquisition unit 51, a movement direction determination unit 52a, a display control unit 54, a usage type determination unit 55, an application execution unit 56, a non-sensing region configuration unit 58, and a processing specification unit 59) of portable terminals 1, 1a, 2, 3, 4, and 5 may be realized a logic circuit (hardware) that is formed in an integrated circuit (an IC chip) and the like, and may be realized in software using a Central Processing Unit (CPU).

In the latter case, the portable terminals 1, 1a, 2, 3, 4, and 5 each include a CPU that executes a command of a program that is a piece of software which realizes each function, a Read Only Memory (ROM) or a storage device (these are referred to as “recording media”), on which the above-described program and various pieces of data are recorded in a computer (or CPU-)-readable manner, a Random Access Memory (RAM) into which the above-described program is loaded and the like. Then, a computer (or the CPU) reads the above-described program from the recording media for execution, and thus the object of the present invention is accomplished. As the recording medium, a “non-transient type medium”, for example, a tape, a disk, a semiconductor memory, a programmable logic circuit, or the like can be used. Furthermore, the above-described program may be supplied to the above-described computer through an arbitrary transfer medium (a communication network, a broadcast wave, or the like) on which the transfer of the program is possible. Moreover, the present invention can also be realized in the form of a data signal that is impressed onto a carrier wave, which is implemented by transferring the above-described program in an electronic manner.

[Overview]

An input device (a portable terminal 1, 1a, or 2) according to a first embodiment of the present invention that is an input device that acquires an operation by an operation object (a finger 94), includes an operation sensing unit (a touch panel 14 or 14a) that senses an operation object that is present within a virtual operation surface that includes an edge of a case 17 of the input device and that is approximately perpendicular to one surface of the case including the edge, and a movement direction determination unit 52a that determines whether the operation object that is sensed by the operation sensing unit moves in a direction toward the edge, or moves in a direction away from the edge, in which a direction of movement of the operation object that is determined by the movement direction determination is acquired as an operation by the operation object.

With this configuration, it is determined whether the operation object that moves within the surface that includes the edge of the case of the input device and that is approximately perpendicular to one surface of the case moves in the direction toward the edge or moves in the direction away from the edge, and the direction of the movement is acquired as the operation. Accordingly, an operation is possible that uses the movement of the operation object along the direction that includes the edge of the case of the input device and that is approximately perpendicular to one surface of the case that includes the edge.

In an input device according to a second embodiment, the movement direction determination unit according to the first embodiment may determine whether the operation object that is sensed by the operation sensing unit moves in one direction or in a direction opposite to the one direction along the edge.

With this configuration, it is determined whether the operation object that is sensed by the operation sensing unit moves in one direction or in a direction opposite to the one direction along the edge. Accordingly, the movement of the operation object can be determined as a combination of movements along two axes (1) in the direction that includes one edge of the case of the input device and that is approximately perpendicular to one surface of the case that includes the edge and (2) the direction along the edge. Consequently, the operation that uses the direction of the movement of the operation object in a two-dimensional manner is possible.

In an input device according to a third embodiment, the movement direction determination unit according to the second embodiment may include a processing specification unit that interprets each of a direction toward the edge, a direction away from the edge, one direction along the edge, and a direction opposite to the one direction, which are determined as directions of the movement of the operation object, into any one of four directions of a cross key, according to a prescribed association.

With this configuration, each of the direction toward the edge, the direction away from the edge, one direction along the edge, and a direction opposite to the one direction is interpreted into any one of the four directions of the cross key. Accordingly, a user can perform a cross key operation in a position in proximity to an end portion of an operation detection surface. Consequently, convenience can be increased, and an intuitive operation can be input.

In an input device according to a fourth embodiment, a screen may be provided to the one surface of the case according to the first to third embodiment, a proximity sensor that detects proximity of the operation object to the screen be superimposed on the screen, and the proximity sensor be caused to function as the operation sensing unit.

In many input devices, each including a screen, the proximity sensor which detects that the operation object approaches the screen is superimposed on the screen, and thus the operation by the contact and proximity to the screen can be input. With this configuration, the movement of the operation object is detected using the proximity sensor that is superimposed on the screen. Accordingly, there is no need to newly provide an operation sensing unit other than the proximity sensor that is superimposed on the screen. Consequently, an increase in the cost of realizing the input device can be suppressed.

In an input device according to a fifth embodiment, the screen may be provided to the one surface of the case according to the first to third embodiments, the operation sensing unit may be the proximity sensor that is provided between the screen and the edge.

With this configuration, using the proximity sensor that is provided between the screen and the edge, the operation object that moves within the surface that includes one edge of the case of the input device and that is approximately perpendicular to one surface of the case is detected. Accordingly, the movement of the operation object that uses the proximity sensor which is provided in a position close to the operation object to be detected can be detected. Consequently, the operation that is performed in the vicinity of the end portion of the case can be detected with precision.

In the first to fifth embodiments, an input device according to a sixth embodiment of the present invention, may further include a grip determination unit (the usage type determination unit 55) that specifies whether a user is gripping the case with his/her right hand or with his/her left hand according to a position with which the user's hand or finger that grips the case is brought into contact with the case, in which the operation sensing unit may sense only the operation object that is present within the virtual operation surface, with the operation object being included in a region in which a finger that is used as the operation object among fingers of the hand that is specified by the grip determination unit is movable.

Among fingers of the user′ hand with which the input device is gripped, a finger that can be used as the operation object, for example, is a thumb of the hand with which the input device is gripped, and the other fingers are used for gripping the case of the input device alone. With this configuration, the user's hand with which the input device is gripped is specified, a region in which with a finger that is used for the operation, among fingers of the specified user's hand, is determined, and a region in which the operation object is sensed is limited to a range of the reach of the finger (for example, the thumb) that is used as the operation object. Accordingly, only the finger (for example, the thumb) that is used as the operation object is sensed, and thus only the operation that uses the finger as the operation object can be acquired and touch information that results from the other fingers that are not used as the operation objects can be canceled (ignored). Consequently, a malfunction due to the contact of only the finger with which the input device is gripped can be precluded.

An input device control method according to a seventh embodiment of the present invention, for use in an input device that acquires an operation by an operation object, includes an operation sensing step of sensing an operation object that is present within a virtual operation surface that includes an edge of a case of the input device and that is approximately perpendicular to one surface of the case including the edge, a movement direction determination step of determines whether the operation object that is sensed in the operation sensing step moves in a direction toward the edge, or moves in a direction away from the edge, and an operation detection step of acquiring a direction of movement of the operation object that is determined in the movement direction determination step, as an operation by the operation object. With the method described above, the same effect as in the first embodiment is achieved.

The input device according to each of the embodiments of the present invention may be realized by a computer. In this case, a control program for the input device, which realizes the input device using the computer by causing the computer to operate as each unit that is included in the input device, and a computer-readable recording medium on which the program is recorded also fall within the scope of the present invention.

The present invention is not limited to each of the embodiments described above, and various modifications to the present invention are possible within the scope of the present invention defined by claims. Embodiments that are implemented by suitably combining technical means that are disclosed according to different embodiments are also included in the technical scope of the present invention. Additionally, new technological features can be formed by combining the technical means that are disclosed according to each of the embodiments.

### INDUSTRIAL APPLICABILITY

The present invention can be used for a multifunctional portable telephone, a tablet, a monitor, a television, and the like. Particularly, the present invention can be used for a comparatively small-sized input device capable of being operated with one hand with which the input device is gripped.

### REFERENCE SIGNS LIST

1, 1a, 2, 3, 4, 5 PORTABLE TERMINAL (INPUT DEVICE)
14, 14a TOUCH PANEL (OPERATION SENSING UNIT OR PROXIMITY SENSOR)
17 CASE
52a MOVEMENT DIRECTION DETERMINATION UNIT
55 USAGE TYPE DETERMINATION UNIT (GRIP DETERMINATION UNIT)
56 APPLICATION EXECUTION UNIT
59 PROCESSING SPECIFICATION UNIT
P DISPLAY SCREEN (SCREEN)

1. An input device that acquires an operation by an operation object comprising:
an operation sensor that senses an operation object that is present within a virtual operation surface that includes an edge of a case of the input device and that is approximately perpendicular to one surface of the case including the edge; and
movement direction determination circuitry that determines whether the operation object that is sensed by the operation sensor moves in a direction toward the edge, or moves in a direction away from the edge,
wherein a direction of movement of the operation object that is determined by the movement direction determination circuitry is acquired as an operation by the operation object.

2. The input device according to claim 1,
wherein the movement direction determination circuitry determines whether the operation object that is sensed by the operation sensor moves in one direction or in a direction opposite to the one direction along the edge.

3. The input device according to claim 2, further comprising:
processing specification circuitry that interprets each of a direction toward the edge, a direction away from the edge, the one direction along the edge, and a direction opposite to the one direction along the edge, which are determined by the movement direction determination circuitry as directions of the movement of the operation object, into any one of four directions of a cross key, according to a prescribed association.

4. The input device according to claim 1,
wherein a screen is provided to the one surface of the case,
wherein a proximity sensor that detects the proximity of the operation object to the screen is superimposed on the screen, and
wherein the proximity sensor is caused to function as the operation sensor.

5. The input device according to claim 1,
wherein a screen is provided to the one surface of the case, and
wherein the operation sensor is a proximity sensor that is provided between the screen and the edge.

6. The input device according to claim 1, further comprising:
grip determination circuitry that specifies whether a user is gripping the case with his/her right hand or with his/her left hand according to a position with which the user's hand or finger that grips the case is brought into contact with the case,
wherein the operation sensor senses only the operation object that is present within the virtual operation surface, which is included in a region in which a finger that is used as the operation object among fingers of the hand that is specified by the grip determination circuitry is movable.

7. A method for controlling an input device that acquires an operation by an operation object, the method comprising:
an operation sensing step of sensing an operation object that is present within a virtual operation surface that includes an edge of a case of the input device and that is approximately perpendicular to one surface of the case including the edge;
a movement direction determination step of determining whether the operation object that is sensed in the operation sensing step moves in a direction toward the edge, or moves in a direction away from the edge; and
an operation detection step of acquiring a direction of movement of the operation object that is determined in the movement direction determination step, as an operation by the operation object.
